(19) United States
(12) Patent Application Publication
(10) Pub. No.: US 2015/0175226 A1
(43) Pub. Date: Jun. 25, 2015

(54) HYDRAULIC TRACK TENSIONING AND RECOIL SYSTEM

(71) Applicant: CATERPILLAR PAVING PRODUCTS INC., Brooklyn Park, MN (US)

(72) Inventors: NICHOLAS B. JOHNSON, DAYTON, MN (US); NICHOLAS J. ARGENZIANO, OTSEGO, MN (US); NATHAN L. MASHEK, SAINT MICHAEL, MN (US); JASON W. MUIR, ANDOVER, MN (US)

(73) Assignee: CATERPILLAR PAVING PRODUCTS INC., Brooklyn Park, MN (US)

(21) Appl. No.: 14/637,413

(22) Filed: Mar. 4, 2015

(51) Int. Cl. B62D 55/30

(52) U.S. Cl. CPC B62D 55/30

(57) ABSTRACT

A hydraulic tensioning system for a tracked undercarriage is configured to position an idler wheel, supported by a frame assembly, relative to a drive sprocket. The hydraulic tensioning system includes at least one fluid actuator unit with a body that defines a recoil chamber, a tension chamber, and a wall in between the two chambers. A piston assembly is positioned between the body and idler wheel. A ram assembly is positioned between the body and frame assembly. A recoil circuit is in fluid communication with the recoil chamber and a tank. A fluid in the recoil chamber is relieved through a relief valve when the idler wheel is displaced. Fluid is introduced to the recoil chamber, urging the idler wheel away from the frame assembly, via the piston assembly. A tensioning fluid within the tension chamber selectively urges the idler wheel away from the frame assembly, via the ram assembly.

### TECHNICAL FIELD

The present disclosure relates generally to track systems for track machines to provide recoil capability and to sustain proper tension in the track chain during operation. More specifically, the present disclosure relates to a hydraulic track tensioning system having a hydraulic recoil circuit for track undercarriage.

### BACKGROUND

Construction machines, such as cold planers, generally run on tracked-bogie units or track units. Each of the track units include a pair of track wheels—one of which may be an idler wheel and the other a drive sprocket—and a track chain installed over the track wheels. The track chain typically sustains the force of impact as the track strikes salient obstacles or uneven terrain during operation. One conventional device applied to counter the forces of impact include a spring-type shock absorber, which for larger machines may be generally packaged within the track unit typically between the pair of track wheels and placed within a central portion of the track unit. However, for smaller track units these shock absorbers are difficult to incorporate between the track wheels and are a challenge to service.

Although spring type shock absorbers are known, they are difficult to incorporate into smaller machines and pose additional challenges to ensure that the track chain is properly tensioned. Current solutions to overcome space restrictions include at least one of notching a pivot pin used in the associated assembly, changing the pin to two cantilevered welded shafts on a related track frame, or the use of two spring and/or grease assemblies in a manner to reduce overall required space for the shock absorber.

Chinese Patent 102717843 A relates to a track-tensioning device used in crawlers or hydraulic excavators. Although this reference discloses an apparatus that assists in absorption of shocks in a crawler during recoil events, room remains to simplify such requirements in construction machines.

Accordingly, the system and method of the present disclosure solves one or more problems set forth above and/or other problems in the art.

### SUMMARY OF THE INVENTION

Various aspects of the present disclosure illustrate a hydraulic tensioning and recoil system for a tracked undercarriage. The hydraulic tensioning system is configured to position an idler wheel, relative to a drive sprocket, to tension a track chain. A frame assembly supports the idler wheel. The hydraulic tensioning system includes at least one fluid actuator unit disposed between the idler wheel and the drive sprocket. The fluid actuator unit has a body, which defines a recoil chamber and a tension chamber. A wall is disposed within the body to separate the recoil chamber from the tension chamber. Further, a piston assembly is disposed within the recoil chamber and is positioned between the body and the idler wheel. Similarly, a ram assembly is disposed within the tension chamber and positioned between the body and the frame assembly. The hydraulic tensioning system includes a recoil circuit, which has a fluid supply in fluid communication with the recoil chamber. A tank is in fluid communication with the recoil chamber and a relief valve is disposed between the recoil chamber and the tank. During an impact event of the idler wheel, a fluid in the recoil chamber is relieved through the relief valve in response to displacement of the idler wheel. The fluid is introduced to the recoil chamber by the fluid supply during a recoil event. The fluid urges the idler wheel away from the frame assembly via the piston assembly. Further, a tensioning fluid is introduced to the tension chamber of the body of the fluid actuator unit to selectively urge the idler wheel away from the frame assembly through the ram assembly.

### BRIEF DESCRIPTION OF THE DRAWINGS

FIG. 1 is a side view of a construction machine adapted with front and rear track units, in accordance with the concepts of the present disclosure;

FIG. 2 is a perspective view of one of the track units of FIG. 1 including a fluid actuator unit, in accordance with the concepts of the present disclosure;

FIG. 3 is an enlarged view of the track unit with the drive sprocket and track chain removed to better show the fluid actuator unit of FIG. 2, in accordance with the concepts of the present disclosure;

FIG. 4 is a schematic, and partial sectional view of the fluid actuator unit of FIG. 3, set forth to aid in explaining the tension and recoil structures of the fluid actuator unit, in accordance with the concepts of the present disclosure; and

FIG. 5 is a diagrammatical view of an exemplary hydraulic recoil circuit included within the machine shown in FIG. 1, which supplies the actuator unit with tensioning and recoil functions, in accordance with the concepts of the present disclosure.

### DETAILED DESCRIPTION

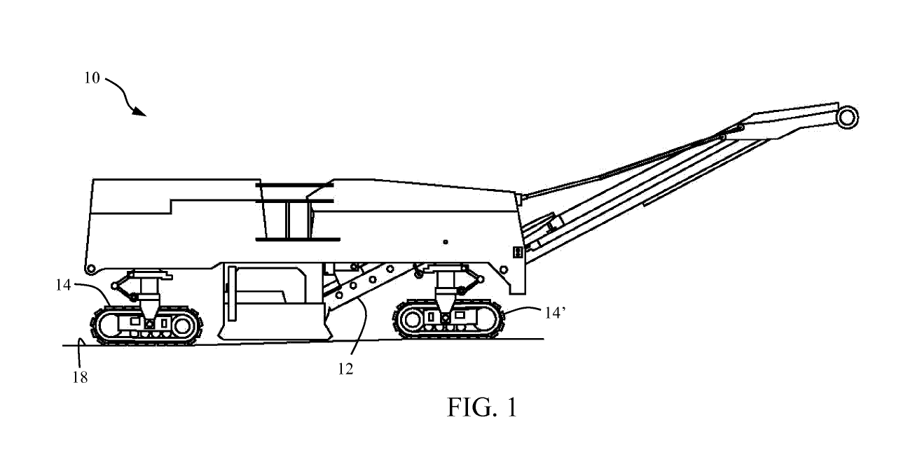

Referring to FIG. 1, there is shown a machine 10. The machine 10 may be a construction machine, such as a cold planar. However, an application of the present disclosure may extend to other track-type machines, such as excavators and track type tractors. Machine 10 may be associated with mining, agriculture, forestry, construction, and/or other industrial applications. Moreover, concepts of the present disclosure may also extend to systems and sub-systems within other machines and application as well. Wherever possible, the same reference numbers will be used throughout the drawings to refer to the same or the like parts.

The machine 10 includes a machine frame 12, which operably accommodates a first track unit 14—or rear track unit—and a second track unit 14′—or front track unit. Although only one side of the machine 10 is shown, and typically, each machine includes four track units, the present disclosure contemplates any number of track units to suitably support the machine 10, such as a front pair of track units and a pair of rear track units, for example. Collectively, the track units 14, 14′ (together with two additional track undercarriage units) comprise the full set of track units for machine 10, however for simplicity a single track unit may be referred to as track unit 14.

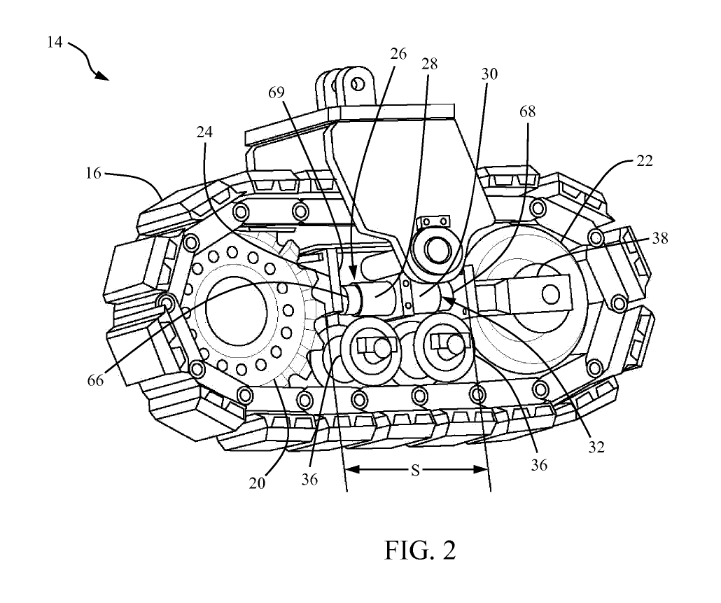

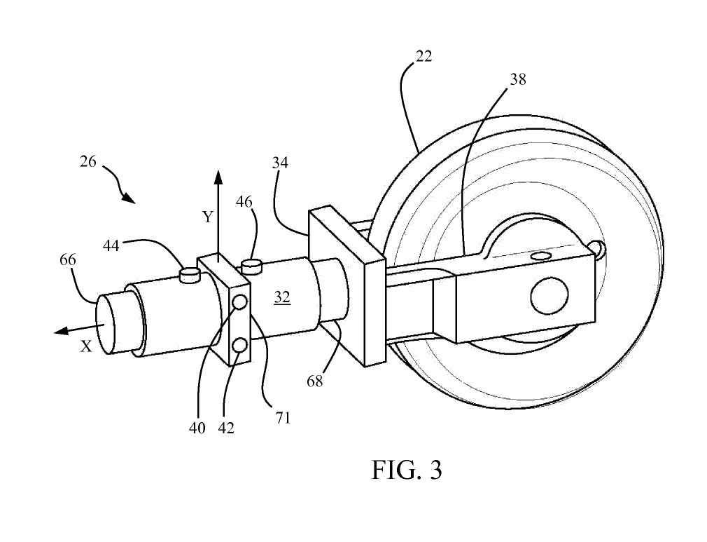

Referring to FIG. 2, an enlarged perspective of the track unit 14 is illustrated. The track unit 14 includes a drive sprocket 20 and an idler wheel 22. The drive sprocket 20 is drivably connected to a track chain 16 since the drive sprocket 20 is internally meshed with the track chain 16. In contrast, the idler wheel 22 is engaged with the track chain 16 and therefore driven to rotate by movement of the track chain 16. A frame assembly 24 is positioned within a space “S” (FIG. 2) that exists between the drive sprocket 20 and the idler wheel 22. The idler wheel 22 is supported by a fork assembly 38 (FIGS. 2 and 3) and in turn the fork assembly 38 and the fluid actuator unit 26 are coupled to the frame assembly 24. The fork assembly 38 and the fluid actuator unit 26, supported by the frame assembly 24 in the Y-axis direction (FIG. 3), however are allowed to move in the X-axis to properly tension the track chain 16 and re-establish tension in the track chain 16 after recoil. Additionally, a set of track rollers 36 (FIG. 2) may be independently connected to the frame assembly 24 to freely rotate and guide the track chain 16, during operation. The space, S, between the drive sprocket 20 and the idler wheel 22 facilitates accommodation of the fluid actuator unit 26, as shown.

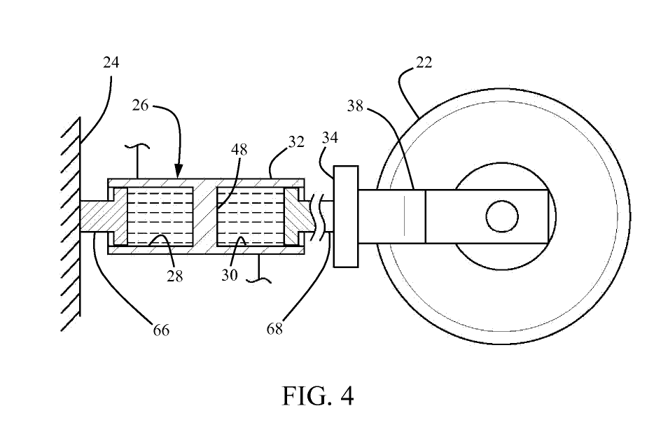

As best shown in FIGS. 3 and 4, the fluid actuator unit 26 functions as a key component for the recoil function and a hydraulic tensioning function for the track chain 16 as will be hereinafter described. The fluid actuator unit 26 has a body 32, which includes a twin chamber, double-acting ram/piston configuration. More specifically, the body 32 defines a tension chamber 28 (and a recoil chamber 30 (FIG. 4). The tension chamber 28 is positioned adjacent to the drive sprocket 20 (FIG. 2), while the recoil chamber 30 is positioned adjacent to the idler wheel 22. A ram assembly 66 is disposed within the tension chamber 28 and is positioned between the body 32 and the frame assembly 24 (FIG. 4). A piston assembly 68 is disposed within the recoil chamber 30 and is positioned between the body 32 and the idler wheel 22. The tension chamber 28 and the recoil chamber 30 are separated by a solid wall 48, which provides a solid barrier in the body 32 and fluidly separates the tension chamber 28 from the recoil chamber 30. The ram assembly 66 may be a rod/piston assembly that is movable along the X-axis (FIG. 3) towards a flange portion 69 (FIG. 2) of the frame assembly 24 to exert tension on the track chain 16 (FIG. 2). The piston assembly 68 may also be a rod/piston assembly however, the piston assembly 68 is movable in both directions along the X-axis (FIG. 3) during a recoil event (FIG. 3). The tension chamber 28 and the recoil chamber 30 are designed to retain hydraulic fluid, lubricant, or other incompressible fluid for example. However, it is envisioned that a lubricant such as grease may be more desirable for use with the tension chamber 28.

Referring to FIGS. 3 and 4, fluid supply ports 40 and 42 are shown disposed in a connector block 71 of the body 32 (FIG. 3). Specifically, the fluid supply port 40 is fluidly connected to the recoil chamber 30 and the fluid supply port 42 is fluidly connected to the tension chamber 28 through the connector block 71. It is envisioned that the connector block 71 may include passages through the solid wall 48, which respectively fluidly connect with the fluid supply ports 40 and 42 such that fluid supply port 40 is fluidly connected with the recoil chamber 30 and fluid supply port 42 is fluidly connected with the tension chamber 28. A fluid exit port 46 is fluidly connected to the recoil chamber 30 and a fluid exit port 44 is fluidly connected to the tension chamber 28 (FIG. 3).

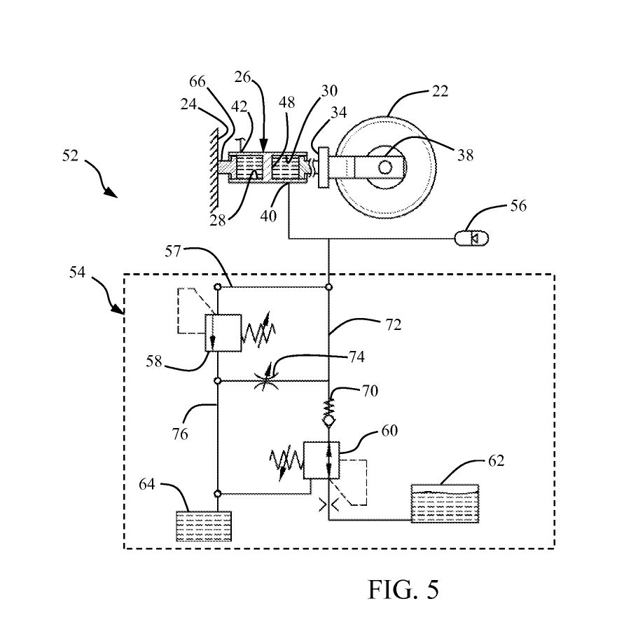

Referring to FIG. 5, the recoil function and hydraulic tensioning function will now be described. The recoil function and the hydraulic tensioning function may be simply referred to as a hydraulic tensioning and recoil system 52, for ease of reference. As shown, the hydraulic tensioning and recoil system 52 includes the fluid actuator unit 26 and the fluid actuator unit 26 is fluidly connected to a recoil circuit 54 that facilitates supply and discharge of the fluid to the recoil chamber 30. The fluid supply port 42 is in fluid communication with the tension chamber 28 (FIG. 3) for introducing fluid pressure into the tension chamber 28 which in turn exerts force on the ram assembly 66. As a result, the fluid pressure will cause the ram assembly 66 to extend along the X-axis (FIG. 3) toward the flange portion 69 (FIG. 2) of the frame assembly 24 which will move the fork assembly 38 and idler wheel 22 away from the frame assembly 24 resulting in tension being applied to the track chain 16 (FIG. 2). The fluid exit port 44 within the body 32 of the fluid actuator unit 26 allows fluid to be discharged from the tension chamber 28 if less tension on the track chain 16 is warranted or should the track unit 14 need servicing.

The recoil function of the hydraulic tensioning and recoil system 52 will now be described. The recoil circuit 54 includes a fluid supply 62, which is in fluid communication with the fluid supply port 40 of the recoil chamber 30, via a fluid line 72. An inlet valve 60 is positioned between the fluid supply 62 and the fluid supply port 40 to generally ensure that a threshold inlet pressure is established from the fluid supply 62. In this manner, the fluid supply 62 may be a pressurized fluid supply, which is supplied by any one of a variety of existing hydraulic fluid pressure sources within the machine 10. Alternatively, the fluid supply 62 may be a stand-alone system that supplies hydraulic fluid to the inlet valve 60.

The recoil chamber 30 is also in fluid communication with a tank 64, via a fluid line 76. A relief valve 58 is disposed within the fluid line 76, between the recoil chamber 30 and the tank 64. The tank 64 may be a reservoir to collect excess fluid, which may be discharged, from the recoil chamber 30 or the accumulator 56, during operation. A spring biased, one-way valve or check valve 70 is positioned downstream of the inlet valve 60, to generally protect the fluid supply 62 and inlet valve 60 from a potential pressure surge during a recoil event, hereinafter described. In addition, an orifice or bleed valve 74 may be positioned between fluid line 72 and fluid line 76 to prevent system overpressure by allowing pressure developed during an impact, causing higher pressure in the recoil chamber 30, to be directed to tank 64 through the bleed valve 74. An auxiliary fluid line (not shown) may be installed to facilitate a return supply of fluid to the fluid supply 62, from the tank 64, to refill the fluid supply 62 as needed.

The accumulator 56 is in fluid communication with the recoil chamber 30, as shown. The accumulator 56 generally facilitates accommodation of shocks sustained during a recoil event that are up to a minimum predefined threshold pressure. However, a pressure shock, which may be caused from a sudden impact of the track unit 14 with an object, for example, may generate a pressure spike, which will then be controlled by directing the higher pressure fluid to tank 64, through the relief valve 58.

It may be seen that the fluid supply port 40 of the recoil chamber 30 (FIG. 3) is in fluid communication with the recoil circuit 54 and pressure is discharged to tank 64 through the recoil circuit 54 during the recoil event followed by fluid being replenished within the recoil chamber 30 through the supply port 40 by the fluid supply 62. As the pressure in the recoil chamber 30 increases after the recoil event from the fluid supply 62, providing fluid to the supply port 40—and the recoil chamber 30 of the fluid actuator unit 26—the pressure exerted on the piston assembly 68 causes movement of the piston assembly 68 towards the idler wheel 22. This movement of the piston assembly 68, in turn pushes on a flange 34 portion (FIG. 3) of the fork assembly 38 resulting in tension being applied to the track chain 16 (FIG. 2).

### INDUSTRIAL APPLICABILITY

Referring to FIG. 5, during operation, the machine 10 (FIG. 1) may be driven over an uneven terrain (work surface 18) or impact an object on a roadbed, for example. The recoil event occurs when the track chain 16 absorbs this impact and concomitantly transfers the impact to the idler wheel 22. The idler wheel 22 is displaced in a direction along the X-axis (FIG. 3) and towards the frame assembly 24. The piston assembly 68 within the recoil chamber 30 of the fluid actuator unit 26 is correspondingly displaced, which causes the pressure of the fluid housed within the recoil chamber 30 to be increased. As a result, at least a portion of the fluid in the recoil chamber 30 is directed to the recoil circuit 54 and the accumulator 56 through the supply port 40. Since the relief valve 58 is in fluid communication with the accumulator 56 through line 57, the relief valve 58 may open if the pressure reaches a threshold pressure. If this threshold pressure is not met then the accumulator 56 will absorb the discharged fluid. If the force of impact is significant, during the recoil event, the pressure in the line 57 will cause the relief valve 58 to open and the fluid will be directed to the tank 64 through fluid line 76. The recoil event also includes the recoil chamber 30 being replenished with fluid as is hereinafter described. As the pressure of the fluid being discharged from supply port 40 (through line 57) subsides, the fluid pressure of the fluid supply 62 (being directed to the supply port 40 in the recoil chamber 30 through the inlet valve 60 and check valve 70) is allowed to be directed to the supply port 40. Fluid supply 62, inlet valve 60, and check valve 70, work in concert to provide fluid at a predetermined supply pressure to the supply port 40. As a result, this fluid provided by fluid supply 62 is supplied to the recoil chamber 30 via the fluid supply port 40.

Therefore, the recoil event coincides with the fluid in the recoil chamber 30 being relieved through the relief valve 58 in response to a displacement of the idler wheel 22 during an impact of the track unit 14 and the fluid supply 62 introduces fluid supply to the recoil chamber 30. This exerts pressure on the piston assembly 68 and urges the idler wheel 22 away from the frame assembly 24. This returns the idler wheel 22, and in turn the track chain 16, to its original position and tension.

A tensioning event will now be described. It is envisioned that during periodic maintenance, fluid is selectively introduced to the tension chamber 28 of the body 32 of the fluid actuator unit 26 through supply port 42, to urge the idler wheel 22 away from the frame assembly 24 via the ram assembly 66. The tensioning event may coincide with service personnel identifying that the tension in the track chain 16 (FIGS. 1 and 2) is too loose (the track chain 16 may have a pronounced sag, for example) and therefore the tension event may be initiated. It is envisioned that a one way check valve (not shown) be placed in fluid communication with the supply port 42 of the tension chamber 28 of the body 32 to ensure that fluid pressure is not unexpectedly discharged as the service personnel accesses the supply port 42 to initiate the tensioning event.

By incorporating the hydraulic tensioning and recoil system 52, the track unit 14 includes a compact assemblage to fit in the space, S, (FIG. 2) which hydraulically interfaces with the recoil circuit 54. Since the fluid supply 62 for recoil circuit 54 may comprise any available source of suitable fluid such as, for example, implement supply fluid, transmission supply fluid, engine lubrication supply fluid and any other source of fluid known to those having ordinary skill, then few if any extra components and systems are needed to equip machine 10 with such circuit.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A hydraulic tensioning and recoil system for a tracked undercarriage to position an idler wheel relative to a drive sprocket to tension a track chain, the idler wheel being supported by a frame assembly, the hydraulic tensioning and recoil system comprising:
at least one fluid actuator unit disposed between the idler wheel and the drive sprocket, the at least one fluid actuator unit including
a body defining a recoil chamber and a tension chamber;
a wall disposed within the body and separating the recoil chamber and the tension chamber;
a piston assembly disposed within the recoil chamber and being positioned between the body and the idler wheel;
a ram assembly disposed within the tension chamber and being positioned between the body and the frame assembly; and
a recoil circuit including a fluid supply in fluid communication with the recoil chamber of the body of the at least one fluid actuator unit, a tank in fluid communication with the recoil chamber and a relief valve disposed between the recoil chamber and the tank;
wherein a fluid in the recoil chamber being relieved through the relief valve in response to displacement of the idler wheel during an impact event of the idler wheel and the fluid being introduced to the recoil chamber by the fluid supply during a recoil event to urge the idler wheel away from the frame assembly through the piston assembly;
wherein a tensioning fluid being introduced to the tension chamber of the body of the at least one fluid actuator unit to selectively urge the idler wheel away from the frame assembly through the ram assembly.
